(19) United States
(12) Patent Application Publication
(10) Pub. No.: US 2003/0088985 A1
(43) Pub. Date: May 15, 2003

(54) Note magnet assembly with letter blade

(76) Inventor: Te-Ming Huang, Taipei (TW)

Correspondence Address: BACON & THOMAS, PLLC, 625 SLATERS LANE, FOURTH FLOOR, ALEXANDRIA, VA, 22314

(21) Appl. No.: 09/987,283

(22) Filed: Nov. 14, 2001

(51) Int. Cl. B26B 1/00; B26B 11/00

(52) U.S. Cl. 30/151; 30/123

(57) ABSTRACT

A note magnet includes a base and a cover wherein a magnet is connected to an underside of the base. An operation member is rotatably mounted to a post in the base and an end of the operation member is accessed via a first opening of the base. A blade is connected to the operation member and movably extends through a second opening of the base when the end of the operation member is pushed. The not magnet is optionally adhered to a note holder which has a magnet on its bottom.

### FIELD OF THE INVENTION

The present invention relates to a note magnet assembly having a magnet connected to a casing and a blade is movably received in the casing so as to be used as a letter knife.

### BACKGROUND OF THE INVENTION

A conventional note magnet is simply a magnet connected to a decoration member. The magnet can be conveniently used to position notes on a metal plate and the decoration member has its decoration feature. Although the magnets are convenient for the users to organize the notes, only one function is expected and which is not satisfied for the modem trend of office appliances.

### SUMMARY OF THE INVENTION

In accordance with one aspect of the present invention, there is provided a note magnet assembly which comprises a base having a post extending from an inside thereof and a retaining member is located on the inside of the base. A flange extends from the inside of the base and a first opening and a second opening are respectively defined through the flange. A magnet is connected to an underside of the base. An operation member has a recess and the post extends through the recess. A flexible strip extends from the operation member and an end of the flexible strip is engaged with a retaining member in the base. A protrusion extends from an end of the operation member and extends through the first opening. A blade has a first hole engaged with a first boss on the base, and a second hole defined in an intermediate portion of the blade and engaged with a second boss on the operation member. An end of the blade is movably located in the second opening. A cover is mounted to the base.

The primary object of the present invention is to provide a note magnet assembly wherein a blade is movably received between the base and the cover of the assembly.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show a note magnet assembly of the present invention;

FIG. 2 is a perspective view to show the note magnet assembly of the present invention;

FIG. 3 shows that the blade is received in the assembly when the protrusion is not pushed;

FIG. 4 shows that the blade is extended through the opening of the assembly when the protrusion is pushed;

FIG. 5 shows the note magnet assembly is used to position a note on a board;

FIG. 6 is an exploded view to show the note magnet assembly of the present invention and a note holder, and

FIG. 7 is a perspective view to show the note holder holds notes and the note magnet assembly is adhered on the note holder.

### DETAILED DESCRIPTION OF THE INVENTION

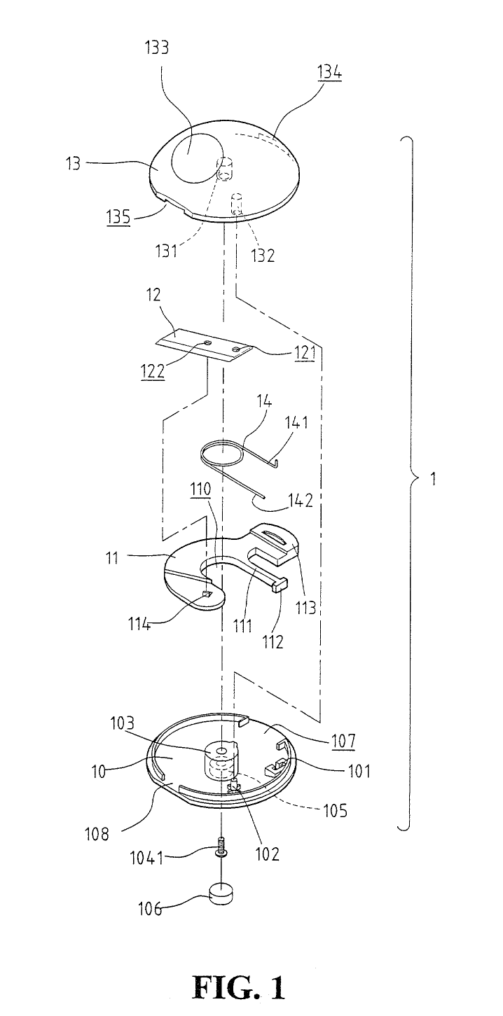

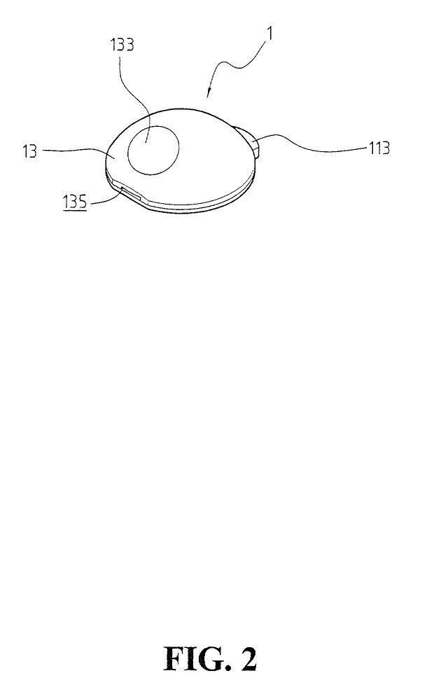

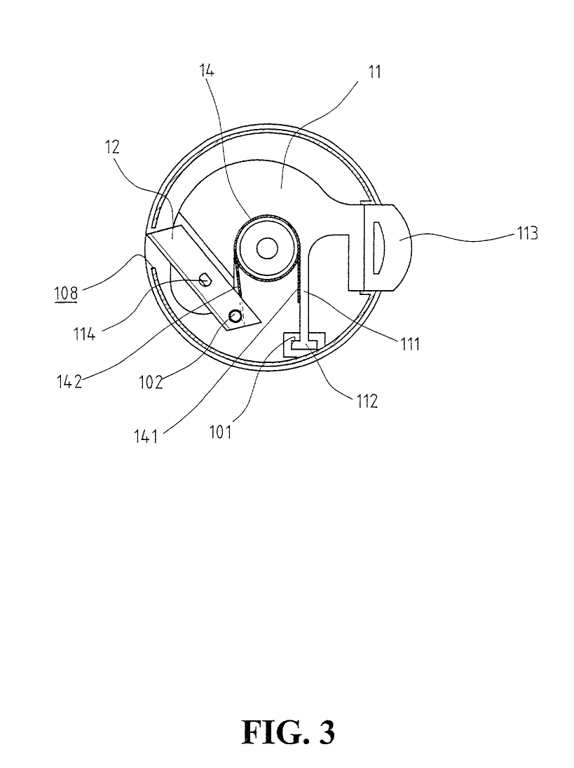

Referring to FIGS. 1, 2 and 3, the note magnet assembly 1 of the present invention comprises a base 10, a cover 13 connected to the base 10 and a blade 12 movably received between the cover 13 and the cover 13. The base 10 has a post 103 extending from an inside thereof and a retaining member 101 is located on the inside of the base 10. A first boss 102 extends from the inside of the base 10. A flange extends from the inside of the base 10 and a first opening 107 and a second opening 108 are respectively defined through the flange. A magnet 106 is received in a recess 105 defined in an underside of the base 10.

An operation member 11 has a recess 110 and the post 103 extends through the recess 110. The recess 110 is large enough so that a gap is defined between the recess 110 and the post 103. A flexible strip 111 extends from the operation member 11 and an end 112 of the flexible strip 111 is engaged with the retaining member 101. A second boss 114 extends from a side at a first end of the operation member 11 and a protrusion 113 extends from a second end of the operation member 11. The protrusion 113 extends through the first opening 107. A torsion spring 14 is mounted to the post 103 and includes two legs 141, 142. The leg 141 is urged against the end 112 of the flexible strip 111 and the other leg 142 is engaged with the first boss 102.

The blade 12 has a first hole 121 defined in a first end thereof and the first hole 121 is engaged with the first boss 102. A second hole 122 is defined in an intermediate portion of the blade 12 and engaged with the second boss 114. A second end of the blade 12 is located in the second opening 108 when the protrusion 113 is not pushed.

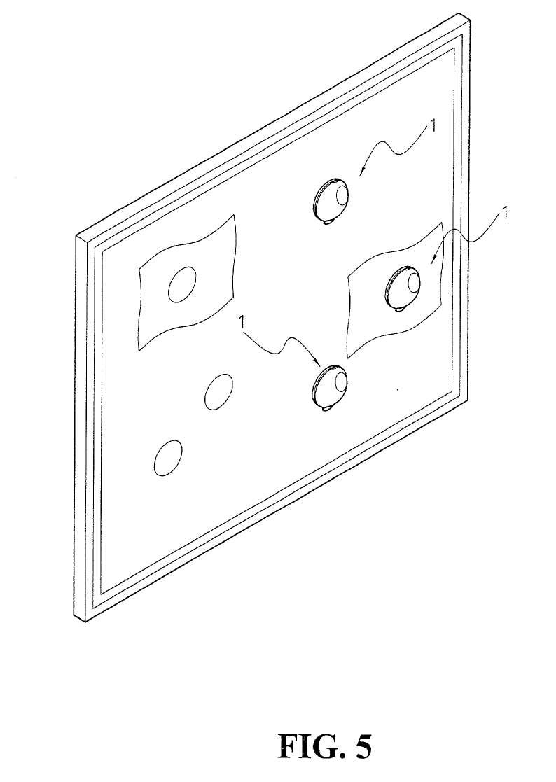

The cover 13 has two notches 134, 135 located corresponding to the first opening 107 and the second opening 108. A finger recess 133 is defined in an outside of the cover 13 for convenience of touch by users. The cover 13 has a tube 131 extending from an inside thereof and a bolt 1041 extends through the post 103 and is engaged with the tube 131 to connect the cover 13 to the base 10. Another tube 132 extending from the inside of the cover 13 is mounted to the first boss 102. The magnet 106 allows the note magnet assembly 1 to be adhered on a metal board to position a note as shown in FIG. 5.

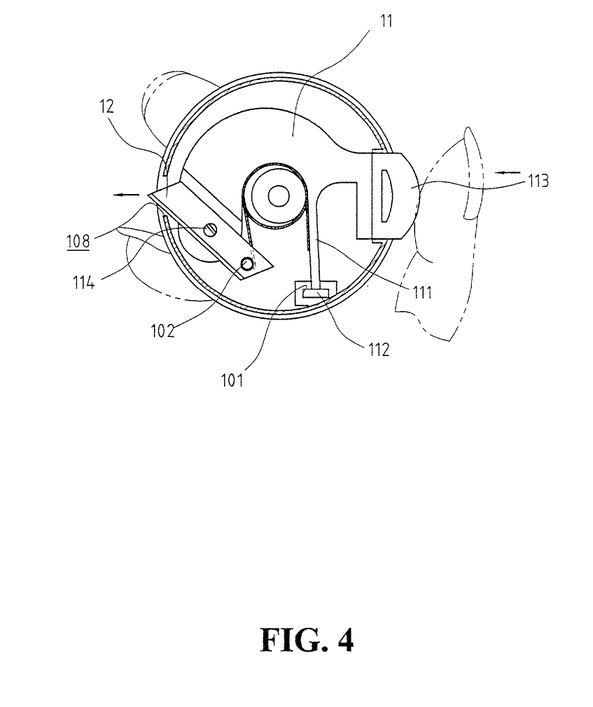

As shown in FIG. 4, when pushing the protrusion 113, the operation member 11 is pushed toward the post 103 and the flexible strip 111 provides flexibility to allow an end of the blade 12 to be rotated about the first boss 102 and to extend through the second opening 108. The blade 12 is used to cut envelopes.

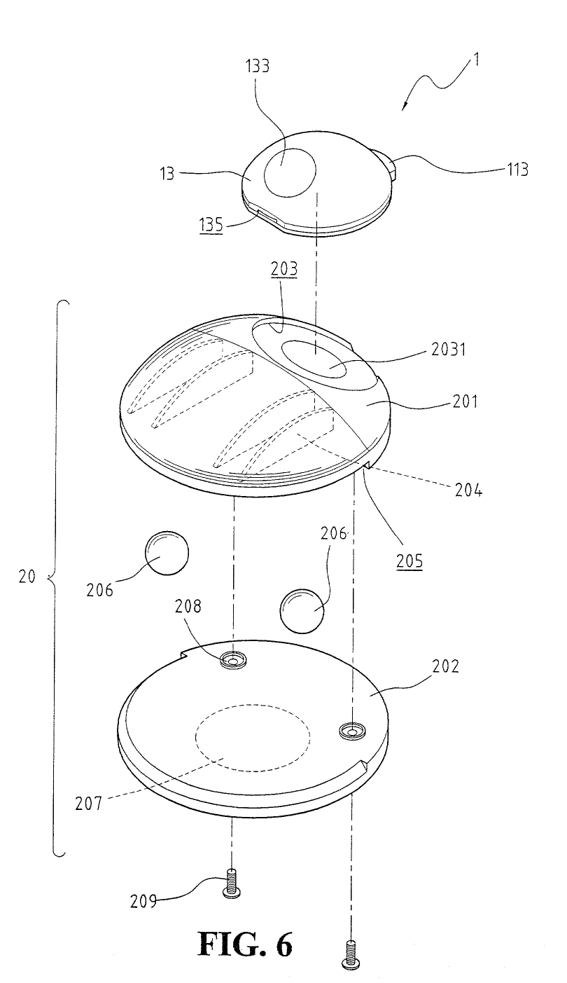

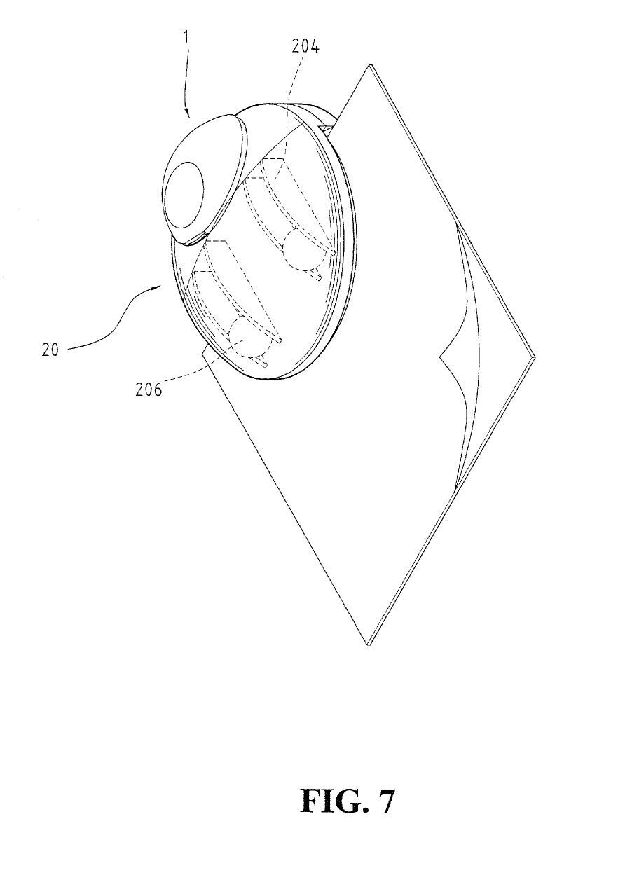

As shown in FIG. 6, a note holder 20 is cooperated with the note magnet assembly 1. The note holder 20 includes a first part 201 and a second part 202. A slot 205 is defined between the first part 201 and the second part 202. Two pairs of plates 204 extend from an inside of the first part 201 and two balls 206 are respectively and movably retained between the two pairs of plates 204. A magnet 207 is connected to a bottom of the note holder 20 and two bolts 209 extend through holes 208 defined through the second part 202 and are engaged with the first part 201. A receiving area 203 is defined in a top of the holder 20 and a metal member 2031 is located in the receiving area 203. The magnet 106 is adhered to the metal member 2031 in the receiving area 203. As shown in FIG. 7, notes can be inserted in the slot 205 and are clamped by the balls 206 which rolls downward due to the gravity.

While we have shown and described the embodiment in accordance with the present invention, it should be clear to those skilled in the art that further embodiments may be made without departing from the scope of the present invention.

What is claimed is:

1. A note magnet assembly comprising:
a base having a post extending from an inside thereof and a retaining member located on said inside of said base, a first boss extending from said inside of said base, a flange extending from said inside of said base and a first opening and a second opening respectively defined through said flange, a magnet connected to an underside of said base;
an operation member having a recess and said post extending through said recess, a flexible strip extending from said operation member and an end of said flexible strip engaged with said retain member, a second boss extending from a side at a first end of said operation member, a protrusion extending from a second end of said operation member and said protrusion extending through said first opening, a blade having a first hole defined in a first end thereof and said first hole engaged with said first boss, a second hole defined i n an intermediate portion of said blade and engaged with said second boss, a second end of said blade located in said second opening, and
a cover mounted to said base.

2. The assembly as claimed in claim 1, wherein said cover has a finger recess defined in an outside thereof.

3. The assembly as claimed in claim 1, wherein said cover has a tube extending from an inside thereof and a bolt extends through said post and is engaged with said tube.

4. The assembly as claimed in claim 1, further comprising a torsion spring mounted to said post and including two legs, one of said legs engaged with said end of said flexible strip and the other leg engaged with said first boss.

5. The assembly as claimed in claim 1, further comprising a note holder adhered to said magnet on said base, said note holder having a slot defined therein which is adapted to receive notes therein.

6. The assembly as claimed in claim 5, herein said note holder includes a first part and a second part, said slot defined between said first part and said second part, two pairs of plates extending from an inside of said first part and two balls respectively and movably retained between said two pairs of plates.

7. The assembly as claimed in claim 5, wherein said note holder has a receiving area defined in a top of said holder and said magnet is adhered with said receiving area.

8. The assembly as claimed in claim 5, further comprising a magnet connected to a bottom of said note holder.
